(19) United States
(12) Patent Application Publication
(10) Pub. No.: US 2009/0301739 A1
(43) Pub. Date: Dec. 10, 2009

(54) PRESSURE SENSING APPARATUSES, SYSTEMS AND METHODS

(75) Inventors: Andreas Rother, Muenchen (DE); Markus Loehndorf, Muenchen (DE); Volker Taggruber, Muenchen (DE)

Correspondence Address: Patterson, Thuente, Skaar & Christensen, P.A., 4800 IDS Center, 80 South Eighth Street, Minneapolis, MN, 55402, US

(73) Assignee: INFINEON TECHNOLOGIES AG, Neubiberg (DE)

(21) Appl. No.: 12/132,632

(22) Filed: Jun. 4, 2008

(51) Int. Cl. A62C 2/00; A62C 13/62; A62C 37/00; G08B 21/18

(52) U.S. Cl. 169/43; 169/71; 169/61; 340/626

(57) ABSTRACT

In one embodiment, a device comprises a container having a dispensing portion, a contents under pressure within the container, and an integrated circuit (IC) sensor device comprising a pressure sensor in communication with the contents under pressure. In various embodiments, the device can further comprise a fire extinguisher, a diving tank, a diving cylinder, a scuba tank, and an oxygen tank. Other embodiments of the invention relate to methods of monitoring, pressure sensing systems, and sensor and sensing modules.

### BACKGROUND

Hand-held fire extinguishers are commonly found in residential, commercial, office, industrial, and other environments, and are useful for quickly containing and extinguishing fires. The benefits of such fire extinguishers are such that their presence, placement and maintenance are legislatively mandated in many jurisdictions.

Referring to FIG. 1, a typical hand-held fire extinguisher 10 comprises a body 12 holding a pressurized substance, such as water, gas, powder, wet or dry chemical, foam or some other substance (not shown). A standpipe 14 extends into body 12 through a threaded aperture 16. A pressure gauge 18 is coupled to aperture 16 in communication with a regulator portion 20. A flexible hose 22 is coupled to regulator portion 20, such that when extinguisher 10 is activated by squeezing the handle 24, the pressurized contents of body 12 are released through standpipe 14, regulator portion 20 and hose 22.

Pressure gauge 18 typically comprises a mechanical pressure gauge, such as a Bourdon gauge, and displays the pressure of the contents of body 12. Such gauges, however, have a relatively low accuracy, cumbersome size, and can be difficult to read. Furthermore, mechanical gauges cannot provide an active warning, such as a light, sound or other communication signal, when pressure is lost, out of range, or when the contents of body 12 are depleted and thus no longer effective. Rather, the mechanical gauges must be personally checked by service or maintenance personnel, which can be time- and cost-ineffective in facilities in which large numbers of fire extinguishers are deployed and further introduces the opportunity for human error.

### SUMMARY

One embodiment of the invention is a device. The device can comprise a container having a dispensing portion, a contents under pressure within the container, and an integrated circuit (IC) sensor device comprising a pressure sensor in communication with the contents under pressure. In various embodiments, the device can further comprise a fire extinguisher, a diving tank, a diving cylinder, a scuba tank, and an oxygen tank.

Other embodiments of the invention relate to methods of monitoring, pressure sensing systems, and sensor and sensing modules.

### BRIEF DESCRIPTION OF THE DRAWINGS

The invention may be more completely understood from the following detailed description of various embodiments in connection with the accompanying drawings, in which:

FIG. 1 is a diagram of a fire extinguisher according to an embodiment.

FIG. 2 is a diagram of a fire extinguisher according to an embodiment.

FIG. 3 is a diagram of a fire extinguisher according to an embodiment.

FIG. 4 is a diagram of a fire extinguisher according to an embodiment.

FIG. 5 is a diagram of a fire extinguisher according to an embodiment.

FIG. 6 is a block diagram of a sensor module according to an embodiment.

FIG. 7 is a system block diagram according to an embodiment.

FIG. 8A is a system diagram according to an embodiment.

FIG. 8B is a system diagram according to an embodiment.

FIG. 8C is a system diagram according to an embodiment.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

Embodiments of the invention relate to active pressure measurement and monitoring. In one embodiment, pressure sensors based on micro-electromechanical system (MEMS) technology are used to measure and monitor pressurized containers. Embodiments of the invention have applicability to safety relevant systems, such fire extinguishers, air tanks, and other pressurized containers. For example, one or more of the aforementioned pressure sensors can be incorporated into or onto a pressurized container, such as the body of a hand-held fire extinguisher. The absolute pressure inside the container is sensed by the sensor. In one embodiment, the sensed pressure can be transferred in a wired or wireless manner to a local and/or distant monitoring receiver such that the status of the fire extinguisher or other container can be quickly and easily determined.

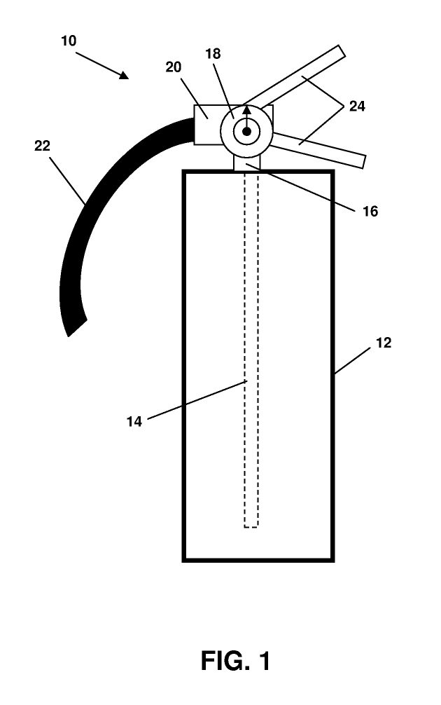

Various embodiments of the invention can be more readily understood by reference to FIGS. 1-8C and the following description. While the invention is not necessarily limited to the specifically depicted application(s), the invention will be better appreciated using a discussion of exemplary embodiments in specific contexts.

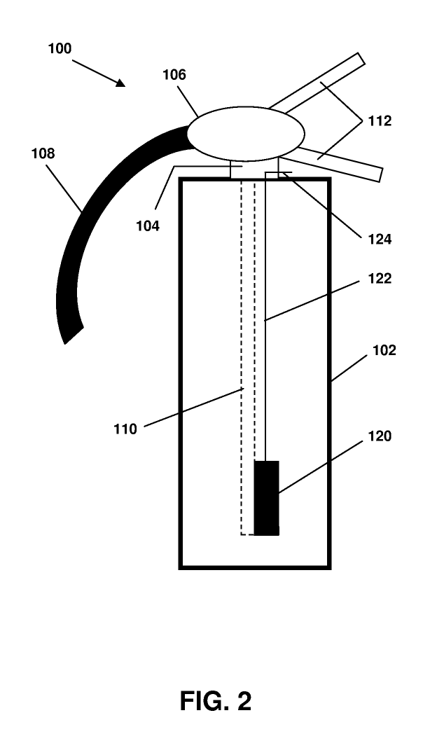

Referring to FIG. 2, one embodiment of a fire extinguisher 100 is depicted. Fire extinguisher 100 comprises a body 102 having an aperture 104. Body 102 can comprise metal, plastic, composite or some other material, and the size, shape and general configuration can vary according to a particular type (e.g., foam vs. powder, residential vs. commercial, etc.) or use of extinguisher 100. A regulator 106 is coupled to body 102 at aperture 104. In one embodiment, aperture 104 and regulator 106 are correspondingly formed so as to facilitate a secure, air-tight connection. For example, aperture 104 and regulator 106 each can be threaded in one embodiment so as to couple together and form a hermetic seal. Other configurations can be used in other embodiments. A plastic or rubber gasket or other device (not shown) can be included to facilitate the hermetic seal. A hose 108 is coupled to regulator 106 such that the contents of body 102 can be dispensed via a standpipe 110, regulator 106 and hose 108 when handles 112 are squeezed together. In one embodiment, hose 108 is a flexible rubber hose, although other materials and configurations can be used in other embodiments.

In one embodiment, fire extinguisher 100 further comprises an internal sensor module 120. In the embodiment of FIG. 2, internal sensor module 120 is located within body 102, mounted or coupled to standpipe 110. In one embodiment, internal sensor module 120 comprises an integrated circuit, such as an application-specific integrated circuit (ASIC). In this embodiment, the components of internal sensor module 120 can be mounted on a printed circuit board and housed in a single, small, environmentally robust package. Such a package is able to withstand the pressure and harsh conditions within body 102 of extinguisher 100.

Internal sensor module 120 can be coupled to an external antenna 124 by a wired connection 122 that extends through body 102 and aperture 104 to facilitate external wireless signal transmissions. In one embodiment, wired connection 122 follows or is coupled to standpipe 110. Such a configuration can be useful in embodiments in which body 102 comprises metal. In another embodiment, antenna 124 is coupled to internal sensor module 120 by other means, such as wirelessly, and wired connection 122 can be omitted.

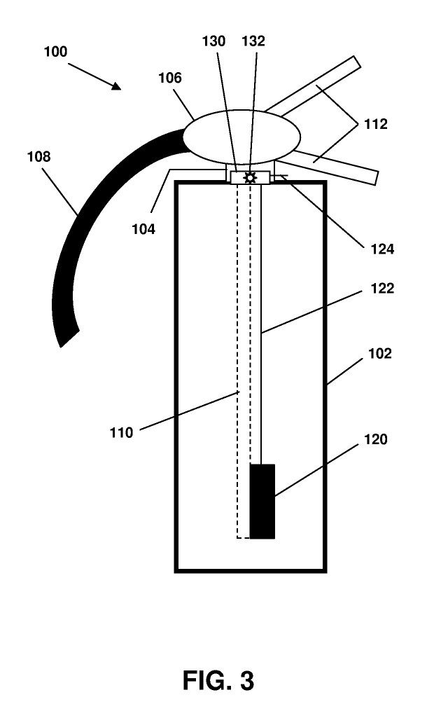

Referring to FIG. 3, extinguisher 100 comprises an external notification module 130 in one embodiment. External notification module 130 is communicatively coupled to sensor module 120 and can provide an immediate local audible and/or visual indicator related to a status of extinguisher 100. For example, external notification module 130 can comprise one or more light emitting diode (LED) indicators 132 to indicate a pressure status of extinguisher 100, such as an illuminated green LED when pressure status is good and an illuminated red LED when pressure status is out of range. Additionally or alternatively, an illuminated yellow LED can be used to indicate that the status is marginal or unknown, communications are unavailable, or that extinguisher 100 needs service or maintenance. In one embodiment, external notification module 130 comprises a liquid crystal display (LCD) to display an actual pressure of the contents of extinguisher 100, a relative pressure indicator (e.g., good, marginal, low), service or maintenance dates or information, or other status information related to extinguisher 100. In another embodiment, external notification module 130 comprises a speaker, buzzer, beeper or other audible indicator to provide status information related to extinguisher 100. External notification module 130 can also comprise various combinations of the aforementioned and other visual and audible indicators.

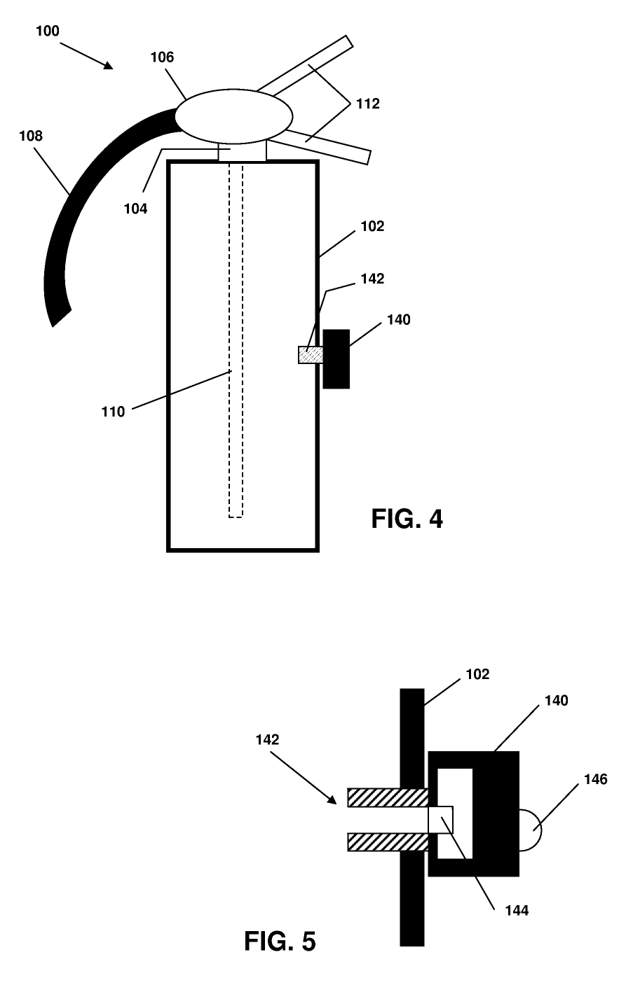

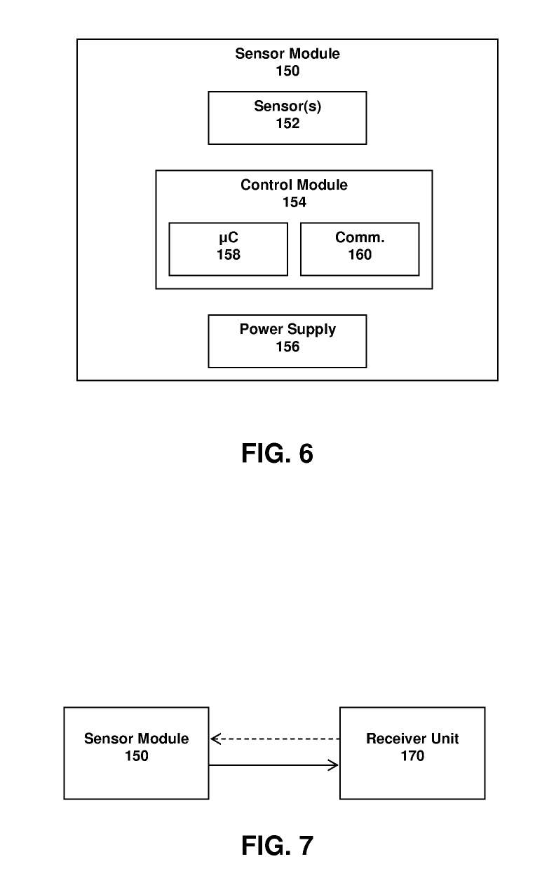

Another embodiment of fire extinguisher 100 is depicted in FIGS. 4 and 5 and comprises an external sensor module 140. External sensor module 140 is similar to internal sensor module 120 but is hermetically mounted to body 102 at an aperture 142. In one embodiment, external sensor module 140 and aperture 142 are correspondingly threaded so as to couple together and form a hermetic seal. In another embodiment, external sensor module 140 is snap-fitted, adhered or affixed to body 102 at aperture 142. In further embodiments, other means are used to hermetically couple external sensor module 140 to body 102 of fire extinguisher 100. For the overall integrity of extinguisher 100, sensor module is permanently affixed to body 102 in one embodiment.

Referring to FIG. 5, external sensor module 140 is configured such that a pressure sensor 144 is exposed to the environment within body 102, although sensors and/or configurations can be used in other embodiments, as is described in more detail below. External sensor module 140 further comprises an LED 146, similar to the external notification module 130 of FIG. 4 but built into external sensor module 140. Similar to the embodiment of FIG. 4, external sensor module 140 can also comprise other visual indicators as well as audible indicators, as described above.

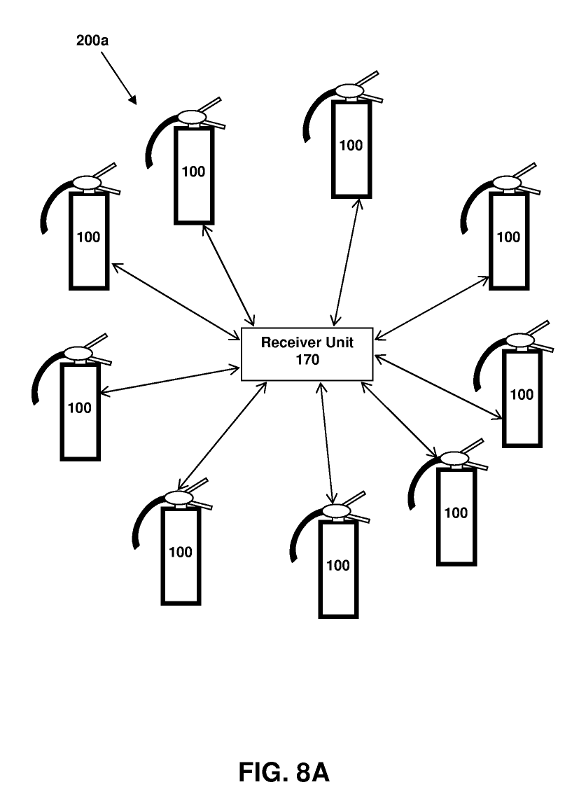

Referring to FIG. 6, a sensor module 150 corresponding generally to either internal sensor module 120 or external sensor module 140 is depicted. While differences between internal sensor module 120 and external sensor module 140 can exist due to their varying placements, many features are the same and therefore will be generally described with reference to sensor module 150. Sensor module 150 comprises sensor(s) 152, a control module 154 and a power supply 156 in one embodiment.

Sensor 152 can comprise a pressure sensor, such as a MEMS-based pressure sensor, in one embodiment. In addition to or instead of a pressure sensor, sensor 152 can also comprise one or more of an acceleration sensor, temperature sensor and/or additional sensors in other embodiments. In embodiments in which sensor 152 comprises a pressure sensor, sensor 152 is adapted to sense an absolute pressure of the contents of fire extinguisher 100. Incorporating a temperature sensor can provide further internal or, in some embodiments, external environmental information related to fire extinguisher 100, while an acceleration sensor can be useful in determining theft, tampering, use or other information about fire extinguisher 100 as a whole.

Power supply 156 is a battery in one embodiment and supplies microcontroller 154 and sensor(s) 152 with any necessary power. The components of sensor module 150 preferably consume a low level of energy to preserve the life of power supply 156, which in various embodiments is not replaceable or rechargeable. Other embodiments comprise alternate types or forms of power supply 156. For example, power supply 156 can be located external to body 102 yet coupled to sensor module 120 in one embodiment. This configuration enables power supply 156 to provide a lower power signal when applicable to indicate replacement is necessary, such as in many household smoke detectors which emit an audible low power signal.

Control module 154 comprises a microcontroller 158 and communications circuitry 160 in one embodiment. In other embodiments, microcontroller 158 and communication circuitry 160 are not integrated and instead comprise separate modules within sensor module 150. Microcontroller 158 can receive data and information from sensor(s) 152 and carry out data analysis within sensor module 150. For example, microcontroller 158 can determine when sequential readings from sensor 152 indicate a trend, such as a loss of pressure and/or an increase in temperature. In another embodiment, data analysis is performed external to sensor module 150 or both internal and external to sensor module 150.

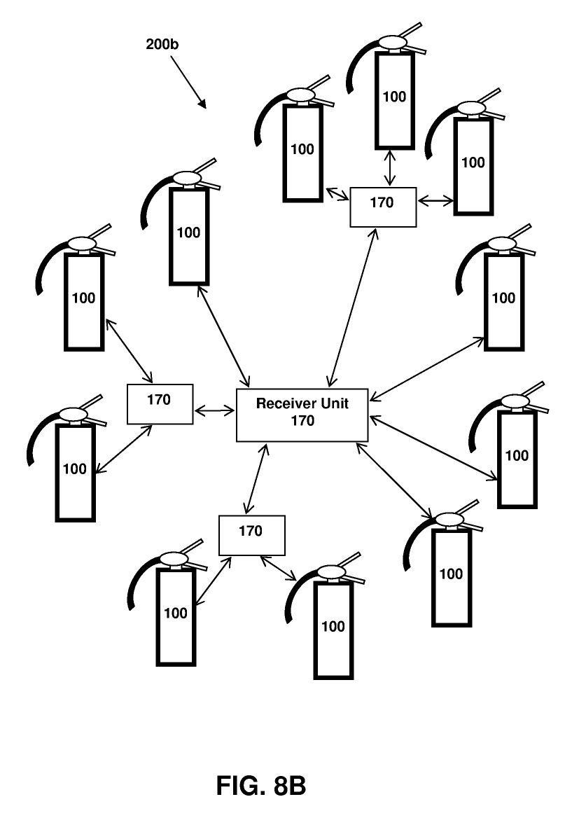

Referring also to FIG. 7, communication circuitry 160 is adapted to transmit data and information between sensor module 150 and an external receiver unit 170 in one embodiment. In the embodiments of FIGS. 2 and 3, communication circuitry 160 passes data and information between control module 154 of internal sensor module 120 and receiver unit 170 via antenna 124, while in the embodiment of FIGS. 4 and 5, an external antenna is directly incorporated in or coupled to external sensor module 140 or may be unnecessary. In other embodiments, communication circuitry 160 also or instead is adapted to transmit data and information between sensor module 150 and external notification module 130 (refer to FIG. 3).

Data and information transmitted from sensor module 150 can include information sensed by sensor(s) 152, data analysis information from control module 154, and information related to the remaining life of power supply 156, as well as other data and information related to sensor module 150. To facilitate communications and so that receiver unit 170 can identify the particular source of communications and information, each extinguisher 100 also comprises a unique identification number or code in one embodiment. In another embodiment, each extinguisher 100 further comprises a global positioning system (GPS) module that can be used to determine locations and data sources.

In one embodiment, two-way communications are implemented, such that receiver unit 170 sends a request and sensor module 150 responds. In another embodiment, only one-way communications initiated by sensor module 150 are implemented to conserve energy. In this embodiment, sensor module 150 can obtain readings from sensor(s) 152 and monitor the status of the contents of extinguisher 100 but only transmit a self-initiated signal to otherwise receivable by receiver unit 170 periodically or when a pressure level or other condition warrants immediate signal transmission.

Receiver unit 170 can be a fixed unit, such as a computer or other device in a facilities management office or area, in one embodiment. Receiver unit 170 can also be located at or communicatively coupled to a security company, corporate or industrial safety officer, local dispatcher or other relevant service or organization. Receiver unit 170 can also comprise a portable device, such as a hand-held computer, in other embodiments. A pressure measuring and monitoring system can also comprise both fixed and mobile units. In some systems, for example, communications between a fixed central receiver 170 and each and every fire extinguisher 100 in a large area may not be practical or possible, and a portable receiver unit 170 can be used to periodically check the status of outlying or other extinguishers 100.

Receiver unit 170 is adapted to provide status information and alerts in various embodiments. For example, receiver unit 170 can transmit data and information to multiple further receivers, such as mobile phones and pagers. In one such embodiment, receiver unit 170 can initiate SMS messages to a pre-programmed mobile phone list or an email message sent to predetermined accounts and addresses.

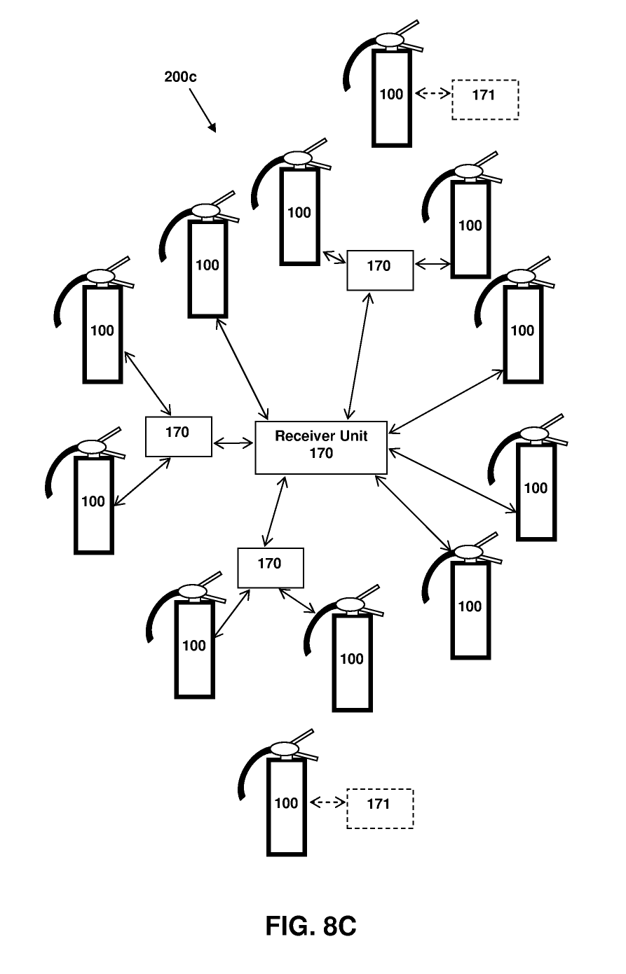

A simplified diagram of one embodiment of a pressure measuring and monitoring system 200 is depicted in FIG. 8A. System 200a comprises a plurality of fire extinguishers 100, each extinguisher 100 comprising one of internal sensor module 120 or external sensor module 140, and receiver 170. System 200a can be implemented in, for example, a corporate office building, a school campus, a hospital, an apartment or other residential complex, an industrial facility, an airport, or virtually any other single- or multi-building environment. In large areas, such as university campuses, multiple receivers 170 can be used such that communications between each fire extinguisher 100 can be achieved. For example, each building in the campus can have a receiver 170 which passes or “hops” communications to a central receiver 170 in a facility management center, as in system 200b shown in FIG. 8B. The intermediary receivers can be the same as or similar to receiver unit 170, or they can be simplified version.

Another network architecture of a pressure measuring and monitoring system 200c is depicted in FIG. 8C. System 200c is similar to system 220b but further comprises a mobile receiver unit 171 for use with outlying extinguishers 100.

As described above with reference to FIG. 7, communications between receiver 170 and each fire extinguisher 100 in systems 200a, 200b, 200c or other configurations can be one-way or two-way. Further, in any of systems 200a, 200b, or 200c, or in other system configurations, a mix of one-way and two-way communications can be used between receivers 170 and fire extinguishers 100. Communications can be wireless, such as radio or infrared, wired or a combination thereof. For example, a lower frequency such as 125 kHz, can be used for triggers, updates and service, while a higher frequency, such as 434 MHz, can be used for other system communications in one embodiment.

In use, and referring generally to the embodiment of FIG. 8A, one or more fire extinguishers 100 comprising a sensor module 150, which can be either an internal sensor module 120 or an external sensor module 140, are distributed throughout some facility. Each extinguisher 100, via its sensor module 150, is communicatively coupled to receiver unit 170. Pressure sensors 152 in each sensor module actively monitor the pressure status of each extinguisher 100. Further, one or more sensor modules 150 can further comprise one or more additional sensors as described above. Sensor module 150 of each extinguisher 150 can periodically transmit status information to receiver unit 170 and/or receiver unit 170 can poll one or more extinguishers 100 for status information. If a low pressure situation at an extinguisher 100 occurs, such as by comparing a pressure sensed by pressure sensor 152 with a predetermined low pressure threshold, sensor module 150 can immediately or upon being polled transmit that information to receiver unit 170. Sensor module 150 can also activate any local notification means, such as LEDs, audible indicators, and/or others as described above.

Upon receiving a low pressure or other indication from an extinguisher 100, receiver unit 170 can provide further notification, such as by providing a visual indicator on a computer screen, sending an SMS message to a mobile phone, activating a pager, sending an email message, or otherwise providing notification that an extinguisher 100 requires service or attention. Additional or alternative responses by receiver unit 170 can also be programmed.

The various apparatuses, systems and methods can advantageously provide active measuring and monitoring of fire extinguishers, either individually or as a plurality. Embodiments of sensors and sensor modules are adapted to be hermetically coupled to or embedded within fire extinguishing devices and can comprise MEMS and integrated circuit (IC) technologies. Data and information can then be transmitted wired or wirelessly from at or internal to a fire extinguishing device to locations external to the fire extinguishing device. Improved system and information management can therefore be provided while at the same time enhancing safety.

Additionally, while described herein with reference to a fire extinguisher system, the sensor modules and communication techniques have many additional applications and therefore can facilitate further active pressure measuring and monitoring systems. For example, sensor modules can be incorporated into other pressurized containers, such as gas or chemical storage units or tanks in industrial, manufacturing, medical, and other facilities. Sensor modules can also have applicability to diving tanks, diving cylinder, and scuba tanks, such as those used in scuba diving, as well as oxygen tanks and other personal air tanks, such as those used for medical and therapeutic purposes.

Although specific embodiments have been illustrated and described herein for purposes of description of an example embodiment, it will be appreciated by those of ordinary skill in the art that a wide variety of alternate and/or equivalent implementations calculated to achieve the same purposes may be substituted for the specific embodiments shown and described without departing from the scope of the present invention. Those skilled in the art will readily appreciate that the invention may be implemented in a very wide variety of embodiments. This application is intended to cover any adaptations or variations of the various embodiments discussed herein, including the disclosure information in the attached appendices. Therefore, it is manifestly intended that this invention be limited only by the claims and the equivalents thereof.

1. A device comprising:
a container having a dispensing portion;
a contents under pressure within the container; and
an integrated circuit (IC) sensor device comprising a pressure sensor in communication with the contents under pressure.

2. The device of claim 1, wherein the device comprises one of a fire extinguisher, a diving tank, a diving cylinder, a scuba tank, or an oxygen tank.

3. The device of claim 1, wherein the IC sensor device is hermetically coupled to an external portion of the container, spaced apart from the dispensing portion.

4. The device of claim 2, wherein the IC sensor device further comprises wireless communications circuitry adapted to communicate information sensed by the pressure sensor.

5. The device of claim 3, wherein the IC sensor device further comprises at least one of an audible status indicator or a visual status indicator.

6. The device of claim 1, wherein the IC sensor device is mounted inside the container.

7. The device of claim 6, wherein the device further comprises a status indicator mounted external to the container, and wherein the status indicator comprises at least one of an audible status indicator and a visual status indicator.

8. A method of monitoring a fire extinguisher comprising:
coupling a micro-electromechanical system (MEMS) pressure sensor to a fire extinguisher;
monitoring a pressure within the fire extinguisher; and
transmitting information related to the pressure within the fire extinguisher to at least one of a location at the fire extinguisher or a location distant from the fire extinguisher.

9. The method of claim 8, wherein the step of coupling further comprises mounting the MEMS pressure sensor internal to the fire extinguisher.

10. A pressure monitoring system comprising:
at least one fire extinguisher device comprising an integrated circuit (IC) sensor device, the IC sensor device comprising a power supply, a pressure sensor in communication with a contents of the fire extinguisher, and communications circuitry;
a receiver device comprising communications circuitry configured to receive communications from the communications circuitry of the IC sensor device.

11. The system of claim 10, wherein the receiver device further comprises a notification system adapted to provide information related to a status of the at least one fire extinguisher determined from the communications received from the communications circuitry of the IC sensor device.

12. The system of claim 10, wherein the IC sensor device is mounted internal to the at least one fire extinguisher.

13. The system of claim 12, wherein the at least one fire extinguisher further comprises an external notification module communicatively coupled with the IC sensor device and configured to provide information related to a pressure sensed by the pressure sensor.

14. The system of claim 10, wherein the IC sensor device is hermetically coupled to an external portion of the at least one fire extinguisher.

15. The system of claim 14, wherein the IC sensor device is spaced apart from a contents-dispensing portion of the at least one fire extinguisher.

16. A sensor module comprising:
a micro-electromechanical system (MEMS) pressure sensor;
a package comprising an aperture and a mounting device formed around the aperture, the aperture configured to expose the pressure sensor to the contents of a fire extinguisher and the mounting device configured to hermetically mount the package to an external portion of the fire extinguisher;
an indicator on an external portion of the package and configured to provide an indication related to a pressure of a contents of the fire extinguisher sensed by the pressure sensor; and
a power supply coupled to the indicator.

17. The sensor module of claim 17, further comprising a control module communicatively coupled to the pressure sensor, the indicator and the power supply and configured to analyze conditions sensed by the pressure sensor.

18. The sensor module of claim 16, further comprising wireless communication circuitry coupled to the control module.

19. The sensor module of claim 16, wherein the mounting device comprises a threaded portion.

20. The sensor module of claim 16, wherein the indicator comprises at least one of a visual indicator and an audible indicator.

21. The sensor module of claim 20, wherein the indicator comprises at least one of a light emitting diode (LED) or a liquid crystal display (LCD).

22. The sensor module of claim 16, further comprising at least one of a temperature sensor or an acceleration sensor.

23. A sensing module comprising:
a micro-electromechanical system (MEMS) pressure sensor;
communications circuitry adapted to transmit data related to an output of the pressure sensor;
a power supply coupled to the communication circuitry; and
a package housing the pressure sensor, the communications circuitry, and the power supply and configured for mounting inside a pressurized device.

24. The module of claim 23, further comprising control circuitry housed in the package and adapted to analyze the output of the pressure sensor.

25. The module of claim 23, wherein the pressurized device comprises one of a fire extinguisher, a diving tank, a diving cylinder, a scuba tank, or an oxygen tank.
